(19) United States
(12) Patent Application Publication
(10) Pub. No.: US 2015/0205134 A1
(43) Pub. Date: Jul. 23, 2015

(54) SYSTEMS, ARTICLES, AND METHODS FOR WEARABLE HEADS-UP DISPLAYS

(71) Applicant: Thalmic Labs Inc., Kitchener (CA)

(72) Inventors: Matthew Bailey, Kitchener (CA); Thomas Mahon, Guelph (CA)

(21) Appl. No.: 14/599,279

(22) Filed: Jan. 16, 2015

Related U.S. Application Data
(60) Provisional application No. 61/928,568, filed on Jan. 17, 2014.

(51) Int. Cl. G02B 27/01; G02B 27/30; G02F 1/01; G06F 1/16; G02B 26/08

(52) U.S. Cl. CPC G02B 27/0172; G06F 1/163; G02B 27/0101; G02B 26/0816; G02F 1/0131; G02F 1/0136; G02B 27/30; G02B 2027/0178; G02B 2027/0132; G02B 2027/014

(57) ABSTRACT

Systems, articles, and methods for transparent displays that are particularly well-suited for use in wearable heads-up display devices are described. Such transparent displays include a register of light sources that sequentially generates light signals representative of portions (e.g., pixels, and sometimes rows or columns of pixels) of an image. Light signals corresponding to the pixels are collimated and directed substantially in-plane with or co-planar to the transparent display and through, over, or across an array of controllable reflectors. Individual controllable reflectors in the array of controllable reflectors that correspond to the approximate pixel positions are activated to selectively reflect the light signals into the field of view of the user. Successive portions of the image are similarly generated and reflected in rapid succession until the entire image is displayed to the user. The controllable reflectors may include reflective microblinds, MEMS-based mirrors, and/or tunable polarization elements such as Kerr cells.

### BACKGROUND

1. Technical Field

The present systems, articles, and methods generally relate to electronic display technologies and particularly relate to electronic display technologies that are well-suited for use in wearable heads-up displays.

2. Description of the Related Art

### Wearable Electronic Devices

Electronic devices are commonplace throughout most of the world today. Advancements in integrated circuit technology have enabled the development of electronic devices that are sufficiently small and lightweight to be carried by the user. Such “portable” electronic devices may include on-board power supplies (such as batteries or other power storage systems) and may be designed to operate without any wire-connections to other, non-portable electronic systems; however, a small and lightweight electronic device may still be considered portable even if it includes a wire-connection to a non-portable electronic system. For example, a microphone may be considered a portable electronic device whether it is operated wirelessly or through a wire-connection.

The convenience afforded by the portability of electronic devices has fostered a huge industry. Smartphones, audio players, laptop computers, tablet computers, and ebook readers are all examples of portable electronic devices. However, the convenience of being able to carry a portable electronic device has also introduced the inconvenience of having one's hand(s) encumbered by the device itself. This problem is addressed by making an electronic device not only portable, but wearable.

A wearable electronic device is any portable electronic device that a user can carry without physically grasping, clutching, or otherwise holding onto the device with their hands. For example, a wearable electronic device may be attached or coupled to the user by a strap or straps, a band or bands, a clip or clips, an adhesive, a pin and clasp, an article of clothing, tension or elastic support, an interference fit, an ergonomic form, etc. Examples of wearable electronic devices include digital wristwatches, electronic armbands, electronic rings, electronic ankle-bracelets or “anklets,” head-mounted electronic display units, hearing aids, and so on.

### Wearable Heads-Up Displays

While wearable electronic devices may be carried and, at least to some extent, operated by a user without encumbering the user's hands, many wearable electronic devices include at least one electronic display. Typically, in order for the user to access (i.e., see) and interact with content presented on such electronic displays, the user must modify their posture to position the electronic display in their field of view (e.g., in the case of a wristwatch, the user may twist their arm and raise their wrist towards their head) and direct their attention away from their external environment towards the electronic display (e.g., look down at the wrist bearing the wristwatch). Thus, even though the wearable nature of a wearable electronic device allows the user to carry and, to at least some extent, operate the device without occupying their hands, accessing and/or interacting with content presented on an electronic display of a wearable electronic device may occupy the user's visual attention and limit their ability to perform other tasks at the same time.

The limitation of wearable electronic devices having electronic displays described above may be overcome by wearable heads-up displays. A wearable heads-up display is a head-mounted display that enables the user to see displayed content but does not prevent the user from being able to see their external environment. A typical head-mounted display (e.g., well-suited for virtual reality applications) may be opaque and prevent the user from seeing their external environment, whereas a wearable heads-up display (e.g., well-suited for augmented reality applications) may enable a user to see both real and virtual/projected content at the same time. A wearable heads-up display is an electronic device that is worn on a user's head and, when so worn, secures at least one electronic display within the field of view of at least one of the user's eyes at all times, regardless of the position or orientation of the user's head, but this at least one display is either transparent or at a periphery of the user's field of view so that the user is still able to see their external environment. Examples of wearable heads-up displays include: the Google Glass®, the Optinvent Ora®, the Epson Moverio®, the Sony Glasstron®, just to name a few.

A challenge in the design of most wearable heads-up display devices is the need to provide focused, high-quality images to the user without limiting the user's ability to see their external environment, and while at the same time minimizing the bulk of the wearable heads-up display unit itself. All of the wearable heads-up display devices available today are noticeably bulkier than a typical pair of corrective eyeglasses or sunglasses and there remains a need in the art for electronic display technology that enables wearable heads-up display devices of more aesthetically-appealing design while simultaneously providing high-quality images to the user without limiting the user's ability to see their external environment.

### BRIEF SUMMARY

A wearable heads-up display may be summarized as including: a support structure that in use is worn on a head of a user; and a first transparent display that is physically coupled to the support structure, wherein the first transparent display is substantially planar and positioned within a field of view of the user when the support structure is worn on the head of the user, and wherein the first transparent display comprises: a first register of light sources positioned near or beyond a periphery of the field of view of the user when the support structure is worn on the head of the user, wherein each light source in the first register of light sources controllably emits a respective light signal substantially in-plane with or co-planar to the first transparent display; and a first array of controllable reflectors arranged substantially in-plane with or co-planar to the first transparent display and positioned within the field of view of the user when the support structure is worn on the head of the user, wherein each controllable reflector in the first array of controllable reflectors is controllably switchable into and between at least two configurations, the at least two configurations including: i) a transparent configuration in which light from external sources within the field of view of the user is transmitted through the controllable reflector and a light signal emitted by a light source in the first register of light sources, if impingent on the controllable reflector, is also transmitted through the controllable reflector; and ii) a reflective configuration in which a light signal emitted by at least one light source in the first register of light sources is reflected by the controllable reflector into the field of view of the user. The first transparent display may be positioned within a field of view of a first eye of the user when the support structure is worn on the head of the user, and the wearable heads-up display may further include: a second transparent display physically coupled to the support structure, wherein the second transparent display is substantially planar and positioned within a field of view of a second eye of the user when the support structure is worn on the head of the user, and wherein the second transparent display comprises: a second register of light sources positioned near or beyond a periphery of the field of view of the second eye of the user when the support structure is worn on the head of the user, wherein each light source in the second register of light sources controllably emits a respective light signal substantially in-plane with or co-planar to the second transparent display; and a second array of controllable reflectors arranged substantially in-plane with or co-planar to the second transparent display and positioned within the field of view of the second eye of the user when the support structure is worn on the head of the user, wherein each controllable reflector in the second array of controllable reflectors is controllably switchable into and between at least two configurations, the at least two configurations including: i) a transparent configuration in which light from external sources within the field of view of the second eye of the user is transmitted through the controllable reflector and a light signal emitted by a light source in the second register of light sources, if impingent on the controllable reflector, is also transmitted through the controllable reflector; and ii) a reflective configuration in which a light signal emitted by at least one light source in the second register of light sources is reflected by the controllable reflector into the field of view of the second eye of the user.

The support structure may have a general shape and appearance of an eyeglasses frame.

The wearable heads-up display may further include: a processor physically coupled to the support structure and communicatively coupled to both the first register of light sources and the first array of controllable reflectors; and a non-transitory processor-readable storage medium physically coupled to the support structure and communicatively coupled to the processor, wherein the non-transitory processor-readable storage medium stores processor-executable display control instructions that, when executed by the processor, cause the processor to: control the respective light signal emitted by each light source in the first register of light sources; and control the respective configuration of each controllable reflector in the first array of controllable reflectors.

Each respective light source in the first register of light sources may include at least one light source selected from the group consisting of: a respective light-emitting diode and a respective organic light-emitting diode.

The first array of controllable reflectors may include X rows and Y columns, wherein X and Y are both integers greater than zero, and the first array of controllable reflectors may further comprise: a first set of X control signal lines, each control signal line in the first set of X control signal lines communicatively coupled to all of the controllable reflectors in a respective row of the first array of controllable reflectors. The first array of controllable reflectors may further comprise: a second set of Y control signal lines, each control signal line in the second set of Y control signal lines communicatively coupled to all of the controllable reflectors in a respective column of the first array of controllable reflectors.

Each controllable reflector in the first array of controllable reflectors may include a respective reflective microblind comprising: a surface formed of a material that is substantially reflective, wherein the reflective microblind is controllably switchable into and between at least two configurations, the at least two configurations including: i) an open configuration in which the reflective microblind is open and light from external sources within the field of view of the user is transmitted through the reflective microblind and a light signal emitted by a light source in the first register of light sources, if impingent on the reflective microblind, is also transmitted through the reflective microblind; and ii) a closed configuration in which the reflective microblind is closed and positioned within a path of a light signal emitted by at least one light source in the first register of sources, wherein the light signal emitted by the at least one light source in the first register of light sources is reflected into the field of view of the user by the reflective microblind when the reflective microblind is in the closed configuration. For the closed configuration of each respective reflective microblind, the reflective microblind may be oriented at an approximately 45 degree angle relative to the path of the light signal emitted by the at least one light source in the first register of light sources.

Each respective controllable reflector in the first array of controllable reflectors may comprise a respective photoelastic modulator. Each respective controllable reflector in the first array of controllable reflectors may comprise a respective Kerr cell. Each Kerr cell shutter may be serially coupled to at least one adjacent Kerr cell shutter with respect to a path of the light signal emitted by at least one light source in the first register of light sources. The wearable heads-up display may further include: a first set of polarizing elements including at least one polarizing element having a first polarization, the first set of polarizing elements positioned in between the first register of light sources and the first array of controllable reflectors and the first set of polarizing elements operative to apply the first polarization to the light signals emitted by the light sources of the first register of light sources. Each respective Kerr cell shutter may comprise: a Kerr cell operative to controllably alter the polarization of the light signal emitted by at least one light source in the first register of light sources; and a reflective polarizing element having the first polarization, the reflective polarizing element oriented at an angle to a path of the light signal emitted by the at least one light source in the first register of light sources, wherein the reflective polarizing element is operative to: i) transmit the light signal emitted by the at least one light source in the first register of light sources when the Kerr cell is not operated to alter the polarization of the light signal emitted by the at least one light source in the first register of light sources; and ii) reflect the light signal emitted by the at least one light source in the first register of light sources when the Kerr cell is operated to alter the polarization of the light signal emitted by the at least one light source in the first register of light sources and redirect the light signal emitted by the at least one light source in the first register of light sources into the field of view of the at least one eye of the user. For the reflective polarizing element of each respective Kerr cell shutter, the reflective polarizing element may be oriented at an approximately 45 degree angle relative to the path of the light emitted by the at least one light source in the first register of light sources.

The wearable heads-up display may further include: a first set of collimators, each collimator in the first set of collimators positioned adjacent a respective one of the light sources in the first register of light sources, wherein each collimator in the first set of collimators directs the light signal emitted by a respective light source in the first register of light sources along a direction that is both: i) substantially in-plane with or co-planar to the first transparent display; and ii) substantially parallel to the respective light signals emitted by the other light sources in the first register of light sources.

A method of operating a transparent display of a wearable heads-up display when the wearable heads-up display is worn on a head of a user may be summarized as including: generating a first set of light signals by a register of light sources, each light signal representative of a respective portion of an image; directing the light signals along a plane that is substantially in-plane with or co-planar to the transparent display and substantially in-plane with or co-planar to an array of controllable reflectors; and activating a first set of controllable reflectors in the array of controllable reflectors to selectively reflect the light signals into a field of view of the user. The method may further include: generating a second set of light signals by the register of light sources, each light signal in the second set of light signals representative of a respective portion of the image; directing the light signals in the second set of light signals along the plane that is substantially in-plane with or co-planar to the transparent display and substantially in-plane with or co-planar to the array of controllable reflectors; and activating a second set of controllable reflectors in the array of controllable reflectors to selectively reflect the light signals in the second set of light signals into the field of view of the user. The first set of light signals may collectively represent a first row portion of the image, and activating a first set of controllable reflectors in the array of controllable reflectors to selectively reflect the light signals into a field of view of the user may include activating a first row of controllable reflectors in the array of controllable reflectors to selectively reflect the light signals into a field of view of the user. The image may include N rows, where N is an integer greater than 1, and the method may further comprise: until i=(N+1), where i is an integer with an initial value of 2, sequentially: generating an i^{th} set of light signals by the register of light sources, the i^{th} set of light signals representative of an i^{th} row of the image; directing light signals in the i^{th} set of light signals along the plane that is substantially in-plane with or co-planar to the at least one transparent display and substantially in-plane with or co-planar to the array of controllable reflectors; activating an i^{th} row of controllable reflectors in the array of controllable reflectors to reflect the light signals in the i^{th} set of light signals into the field of view of the user; and incrementing i by 1.

The array of controllable reflectors may include an array of reflective microblinds, and activating a first set of controllable reflectors in the array of controllable reflectors to selectively reflect the light signals into a field of view of the user may include closing a first set of reflective microblinds in the array of reflective microblinds to selectively reflect the light signals into the field of view of the user from the closed first set of reflective microblinds.

The method may include collimating the light signals by at least one collimator.

The wearable heads-up display may include a processor and a non-transitory processor-readable storage medium communicatively coupled to the processor, wherein the non-transitory processor-readable storage medium stores processor executable display control instructions, and: generating a first set of light signals by the register of light sources may include executing the processor-executable display control instructions by the processor to cause the register of light sources to generate the first set of light signals; and activating a first set of controllable reflectors in the array of controllable reflectors to reflect the light signals into a field of view of the user may include executing the processor-executable display control instructions by the processor to cause the first set of controllable reflectors in the array of controllable reflectors to reflect the light signals into the field of view of the user.

Activating a first set of controllable reflectors in the array of controllable reflectors to selectively reflect the light signals into a field of view of the user may include, for each light signal in the first set of light signals, activating the controllable reflector in the array of controllable reflectors that corresponds to the position of the portion of the image represented by that light signal.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic diagram showing a front view of a transparent display that is well-suited for use in a wearable heads-up display in accordance with the present systems, articles, and methods.

FIG. 2 is an illustrative diagram showing a side view of a transparent display that is well-suited for use in a wearable heads-up display in accordance with the present systems, articles, and methods.

FIG. 3A is an illustrative diagram showing a side view of a transparent display in a first stage of an exemplary use in accordance with the present systems, articles, and methods.

FIG. 3B is an illustrative diagram showing a front view of a transparent display in the first stage of the exemplary use in accordance with the present systems, articles, and methods.

FIG. 3C is an illustrative diagram showing a side view of a transparent display in a second stage of the exemplary use in accordance with the present systems, articles, and methods.

FIG. 3D is an illustrative diagram showing a front view of a transparent display in the second stage of the exemplary use in accordance with the present systems, articles, and methods.

FIG. 3E is an illustrative diagram showing a side view of a transparent display in a third stage of the exemplary use in accordance with the present systems, articles, and methods.

FIG. 3F is an illustrative diagram showing a front view of a transparent display in the third stage of the exemplary use in accordance with the present systems, articles, and methods.

FIG. 3G is an illustrative diagram showing a side view of a transparent display in a fourth stage of the exemplary use in accordance with the present systems, articles, and methods.

FIG. 3H is an illustrative diagram showing a front view of a transparent display in the fourth stage of the exemplary use in accordance with the present systems, articles, and methods.

FIG. 3I is an illustrative diagram showing a side view of a transparent display in a fifth stage of the exemplary use in accordance with the present systems, articles, and methods.

FIG. 3J is an illustrative diagram showing a front view of a transparent display in the fifth stage of the exemplary use in accordance with the present systems, articles, and methods.

FIG. 3K is an illustrative diagram showing a front view of a transparent display and summarizing the cumulative effect of the exemplary use in accordance with the present systems, articles, and methods.

FIG. 4 is an illustrative diagram showing a side view of a transparent display employing reflective microblinds in accordance with the present systems, articles, and methods.

FIG. 5 is an illustrative diagram showing a side view of a transparent display employing sequential Kerr cell shutters in accordance with the present systems, articles, and methods.

FIG. 6 is a perspective view of an exemplary wearable heads-up display employing two transparent displays in accordance with the present systems, articles, and methods.

FIG. 7 is a flow-diagram showing a method of operating at least one transparent display of a wearable heads-up display when the wearable heads-up display is worn on a head of a user in accordance with the present systems, articles, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with portable electronic devices and head-worn devices, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Unless the context requires otherwise, throughout the specification and claims which follow, the word “comprise” and variations thereof, such as, “comprises” and “comprising” are synonymous with “including,” and is inclusive or open-ended (i.e., does not exclude additional, unrecited elements or method acts).

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The various embodiments described herein provide systems, articles, and methods for transparent electronic displays that are particularly well-suited for use in wearable heads-up display devices. The transparent electronic displays described herein each employ: i) a single register of light-emitting elements (i.e., “light sources”) that in use rapidly generate and emit a sequence of portions or components (e.g., rows, columns, or other arrangements) of one or more image(s), and ii) an array of controllable reflection elements (i.e., “controllable reflectors”) that in use each controllably switch into and between at least two configurations: a transparent configuration in which light from external sources passes therethrough and a reflective configuration in which respective portions or components of the one or more image(s) generated and emitted by the register of sources are reflected from their corresponding positions in the transparent electronic display and redirected into the user's field of view. In this way, the transparent electronic displays described herein introduce a very compact design that nevertheless provides improved image resolution and a high level of optical transparency.

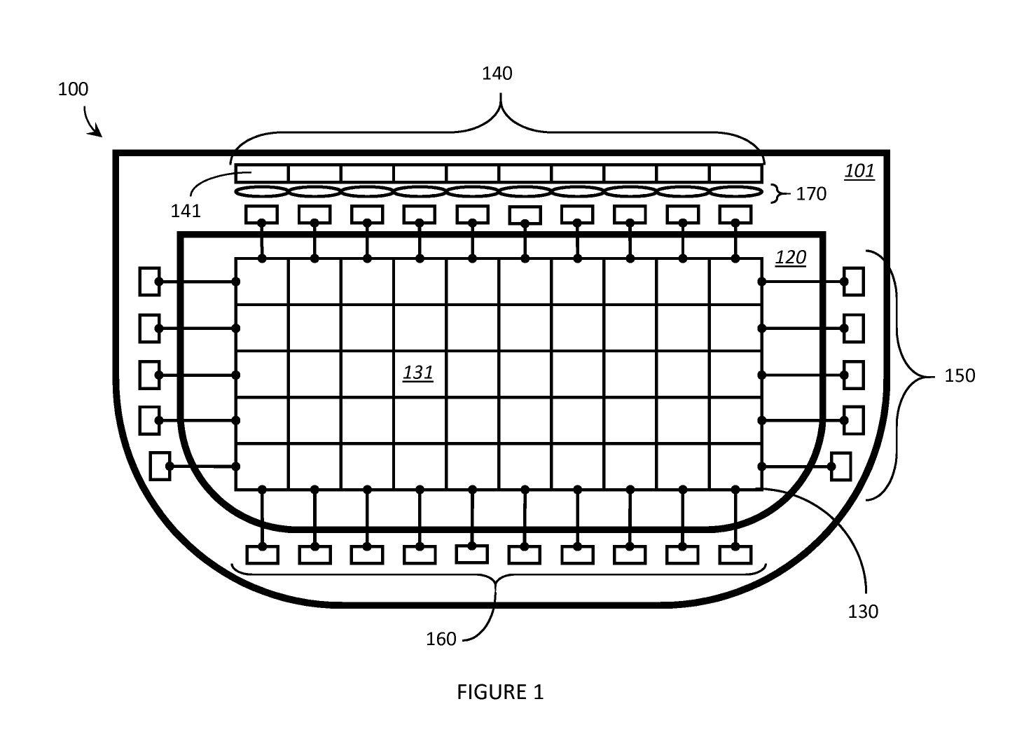

FIG. 1 is a schematic diagram showing a front view of a transparent display element (i.e., a “transparent display”) 100 that is well-suited for use in a wearable heads-up display in accordance with the present systems, articles, and methods. Transparent display 100 includes a support structure 101 that, in the illustrated example, has a general shape and appearance of the portion of a typical set of eyeglasses frame that surrounds the lens. Thus, in an exemplary application transparent display 100 may essentially replace the lens in a typical pair of eyeglasses or sunglasses. As in a typical pair of eyeglasses or sunglasses, frame or support structure 101 at least partially surrounds and is physically coupled to a window 120 made of a transparent material such as glass or plastic. In the present systems, articles, and methods, transparent window 120 may be thought of as a transparent substrate 120 and hereafter is referred to as such. Transparent substrate 120 may be substantially planar in geometry and carries a first array of controllable reflectors 130 that is arranged substantially in-plane with or co-planar to transparent substrate 120.

Throughout this specification and the appended claims, the term “substantially planar” is generally used to describe a geometry for which two spatial dimensions (e.g., the length and the width) are multiple times greater than the third spatial dimension (e.g., thickness) and do not necessarily require that the geometry is flat. For example, a typical eyeglass lens is considered “substantially planar” in the present systems, articles, and methods even though such lenses typical include noticeable curvature.

A first register of light sources 140 is physically coupled to support structure 101. Each individual light source 141 (only one called out in FIG. 1 to reduce clutter) in first register of light sources 140 may include, for example, a respective light-emitting diode (LED) such as an organic light-emitting diode (OLED) and is oriented to, in use, controllably emit a respective light signal along a direction that is substantially in-plane with or co-planar to transparent substrate 120. In this way, each individual light source 141 in first register of light sources 140 controllably emits a respective light signal through, over, or across first array of controllable reflectors 130.

In use, each individual controllable reflector 131 (only one called out in FIG. 1 to reduce clutter) in first array of controllable reflectors 130 controllably switches into and between at least two configurations, the at least two configurations including: i) a transparent configuration in which light from external sources is transmitted through the controllable reflector 131 and a light signal emitted by a light source 141 in the first register of light sources 140, if impingent on the controllable reflector 131, is also transmitted through the controllable reflector 131; and ii) a reflective configuration in which a light signal emitted by at least one light source 141 in first register of light sources 140 is reflected by the controllable reflector 131 into the field of view of the user. In other words, in the reflective configuration a controllable reflector 131 redirects a light signal emitted by a light source 141 from being in-plane with or co-planar to transparent substrate 120 to being substantially normal to transparent substrate 120. First array of controllable reflectors 130 includes a number, X, of rows and a number, Y, of columns, where X and Y are both respective integers greater than zero. In the illustrated example, X is equal to 5 and Y is equal to 10, though a person of skill in the art will appreciate that any number of rows and/or columns may be used. In operation, the total number of individual controllable reflectors 131 in first array of controllable reflectors 130 may be analogous to the total number of pixels in a conventional electronic display. For example, a typical 1080p television screen having a 16:9 aspect ratio employs a resolution of 1920 pixels by 1080 pixels. Transparent display 100 from FIG. 1 may be adapted to provide this resolution by implementing a first array of controllable reflectors that has 1920 columns (i.e., Y=1920) and 1080 rows (i.e., X=1080) for a total of approximately 2,100,000 individual controllable reflectors 131 analogous to 2.1 megapixels.

Controllable reflectors 131 may be, for example, electrically controlled. To this end, transparent display 100 includes a first set of X control signal lines 150 (where X is the number of rows of individual controllable reflectors 131, i.e., X=5), each control signal line in first set of X control signal lines communicatively coupled to all of the respective controllable reflectors 131 in a respective row of first array of controllable reflectors 130. First set of X control signal lines 150 provides row-by-row control of individual controllable reflectors 131 in first array of controllable reflectors 130. In other words, using only first set of X control signal lines 150, the “transparent” or “reflective” state of all of the individual controllable reflectors 131 in each entire row of first array of controllable reflectors 130 may be collectively controlled. In order to provide control of the “transparent” or “reflective” state of the controllable reflectors 131 on an individual basis, transparent display 100 further (and optionally) includes a second set of Y control signal lines 160 (where Y is the number of columns of individual controllable reflectors 131, i.e., Y=10), each control signal line in the second set of Y control signal lines 160 communicatively coupled to all of the respective controllable reflectors 131 in a respective column of first array of controllable reflectors 130. By including both first set of X control signal lines 150 and second set of Y control signal lines, first array of controllable reflectors 130 is controllable as an X-Y addressable array where each individual controllable reflector 131 is individually controllable (i.e., individually addressable) as the point of intersection between a selectively activated control signal line from first set of X control signal lines and a selectively activated control signal line from second set of Y control signal lines.

A challenge in the design and operation of wearable heads-up displays is to provide high-quality images in such close proximity to the user's eye or eyes and to nevertheless enable the user to focus on and clearly discern such images. In accordance with the present systems, articles, and methods, this challenge may be overcome by, for example, collimating the light signals that are directed towards the user's eye(s) so that the image(s) displayed are represented by substantially parallel beams of light. The human eye is adapted to focus easily and in a relaxed state on images represented by parallel beams of light. This is because light from most objects in the mid- and far-range from the eye is, at least to a reasonable approximation, parallel by the time it reaches the eye. Thus, collimating the light signals of a display enables the user to focus on a very close display as easily as if the display was located at a comfortable viewing distance, such as several meters away. To this end, transparent display 100 of FIG. 1 includes a first set of collimators 170, each collimator in the first set of collimators 170 positioned adjacent a respective one of the light sources 141 in first register of light sources 140. In use, each collimator in first set of collimators 170 directs the light signal emitted by a respective light source 141 in first register of light sources 140 along a direction that is both: i) substantially in-plane with or co-planar to transparent substrate 120 and first array of controllable reflectors 130; and ii) substantially parallel to the respective light signals emitted by the other light sources 141 in first register of light sources 140.

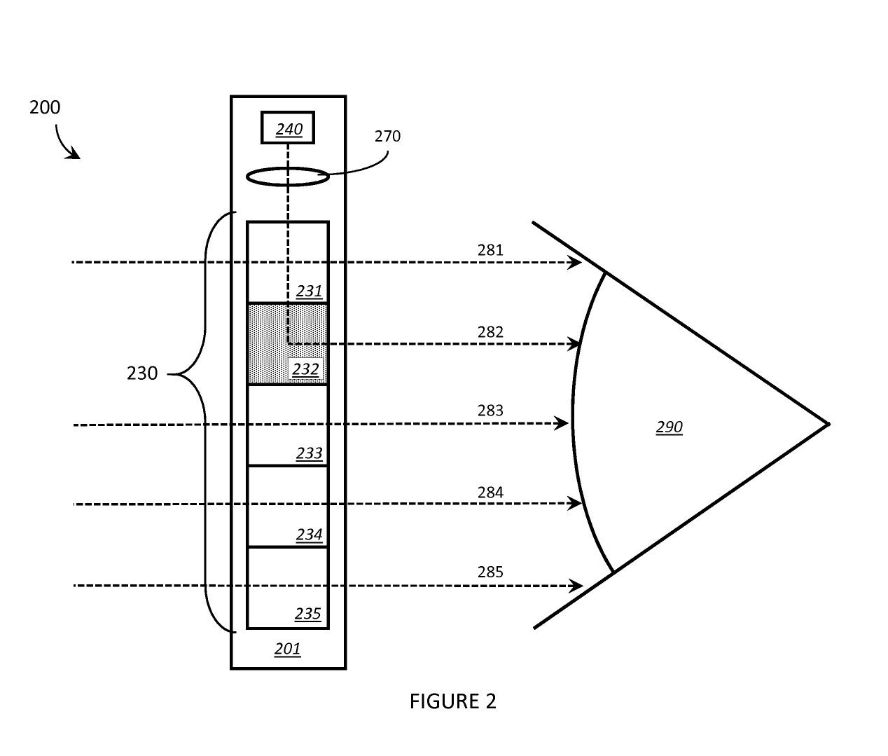

FIG. 2 is an illustrative diagram showing a side view of a transparent display 200 that is well-suited for use in a wearable heads-up display in accordance with the present systems, articles, and methods. Transparent display 200 is substantially similar to transparent display 100 from FIG. 1 in that it includes a support structure 201 (similar to support structure 101 from FIG. 1), a register of light sources 240 (similar to register 140 from FIG. 1, though only a single light source is visible in the side view of FIG. 2), a collimator 270 (similar to first set of collimators 170 from FIG. 1, though only a single collimator is visible in the side view of FIG. 2), and an array of controllable reflectors 230 (similar to first array of controllable reflectors 130 from FIG. 1, though only a single column of five controllable reflectors 231, 232, 233, 234, and 235 is visible in the side view of FIG. 2). The side view of FIG. 2 depicts an exemplary implementation in which controllable reflector 232 is switched into its reflective configuration/state while controllable reflectors 231, 233, 234, and 235 are switched into their respective transparent configurations/states. Light from external sources is depicted as beams 281, 283, 284, and 285 which are transmitted through controllable reflectors 231, 233, 234, and 235, respectively, (in their respective transparent configurations) and impinge directly on a user's eye 290, while a light signal 282 emitted by light source 240 is shown passing through collimator 270 and reflecting off of controllable reflector 232 (in its reflective configuration), where light signal 282 is redirected into the field of view of eye 290. In this way, eye 290 sees light from external sources in beams 281, 283, 284, and 285 and a portion of a projected image in beam 282 generated by light source 240. Since light beam (i.e., light signal) 282 passes through collimator 270, the user is able to see light beam 282 in the same focus as light beams 281, 283, 284, and 285 (which originate from distant external sources).

Returning to FIG. 1, in use first array of controllable reflectors 130 rapidly and sequentially displays portions (e.g., rows or columns) of an image generated and emitted by first register of light sources 140 in a manner that is conceptually similar to the scanning techniques (e.g., progressive scanning or interlacing scanning) employed in conventional, non-transparent displays. The collection of individual light sources 141 is referred to as a “register” 140 herein because, in use, the collection of individual light sources 141 is serially programmed with portions (i.e., rows in the exemplary illustration of FIG. 1) of a complete image, such that the register generates and holds/emits each portion (row) of the image only for a very brief period of time (i.e., the emission time) before moving on (e.g., swapping or shifting) to generate and hold/emit the next portion (row). In this way, an image represented by an array of pixels is rapidly “drawn” row by row using a single register of light sources 140, where the position of each row in the image is provided by the corresponding rows of array of controllable reflectors 130.

Throughout this specification and the appended claims, reference is often made to a “row,” as in “a row of pixels” or “a row of light sources.” Unless the specific context requires otherwise, it should be understood that the term “row” is used for exemplary purposes only and that, in alternative examples, a column or columnar arrangement may be used instead of a row.

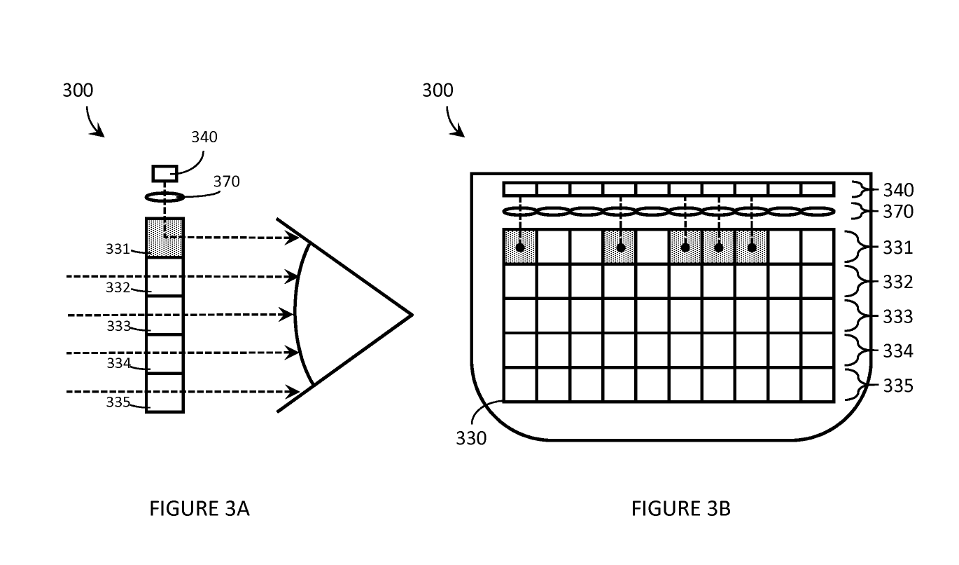

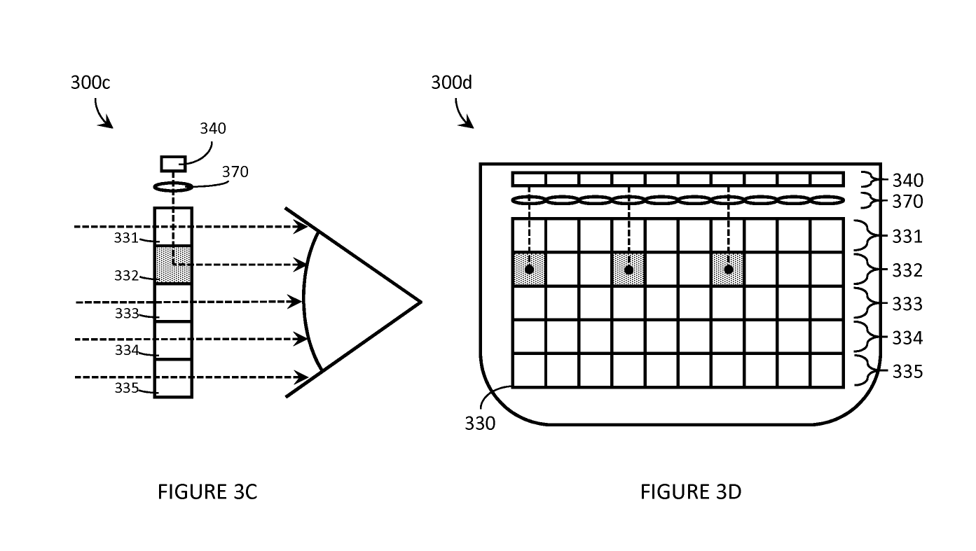

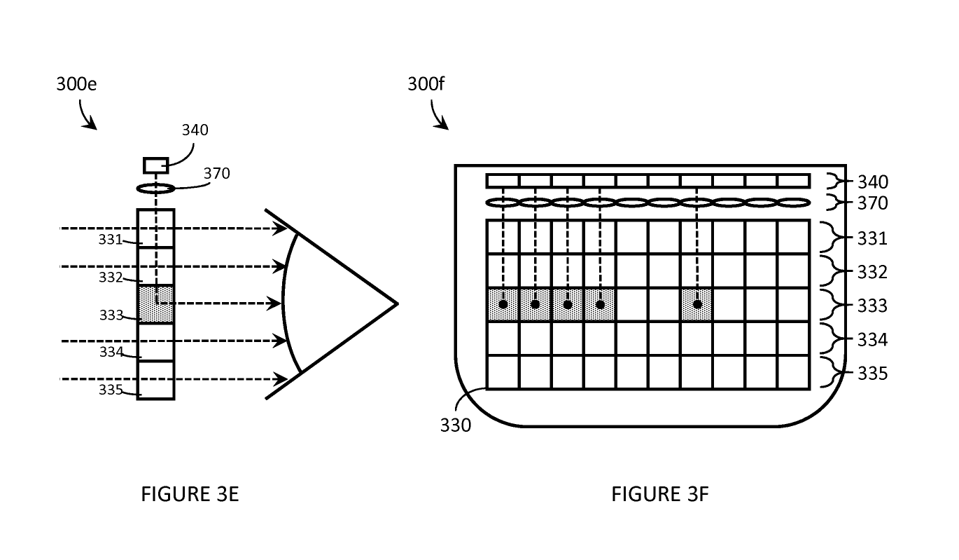

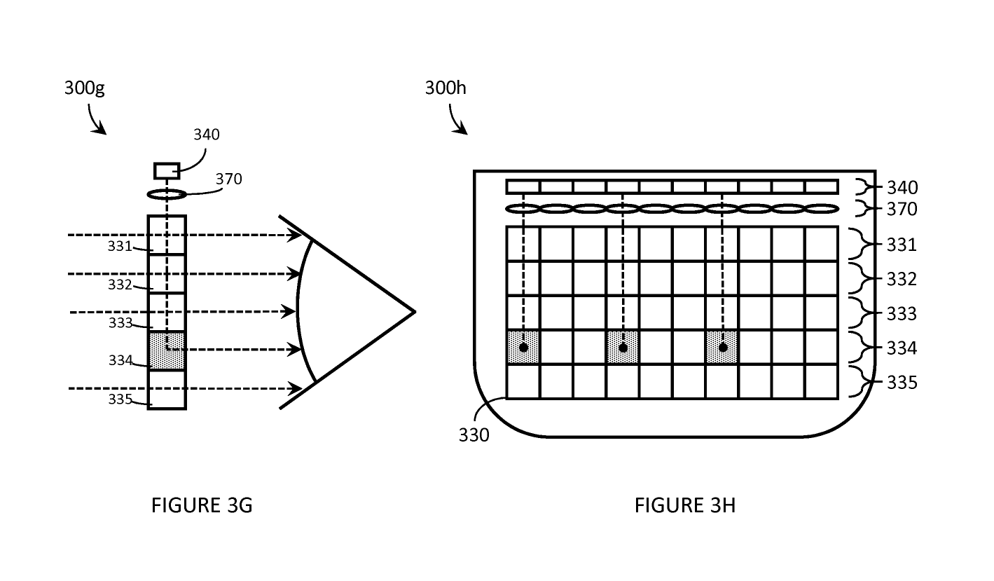

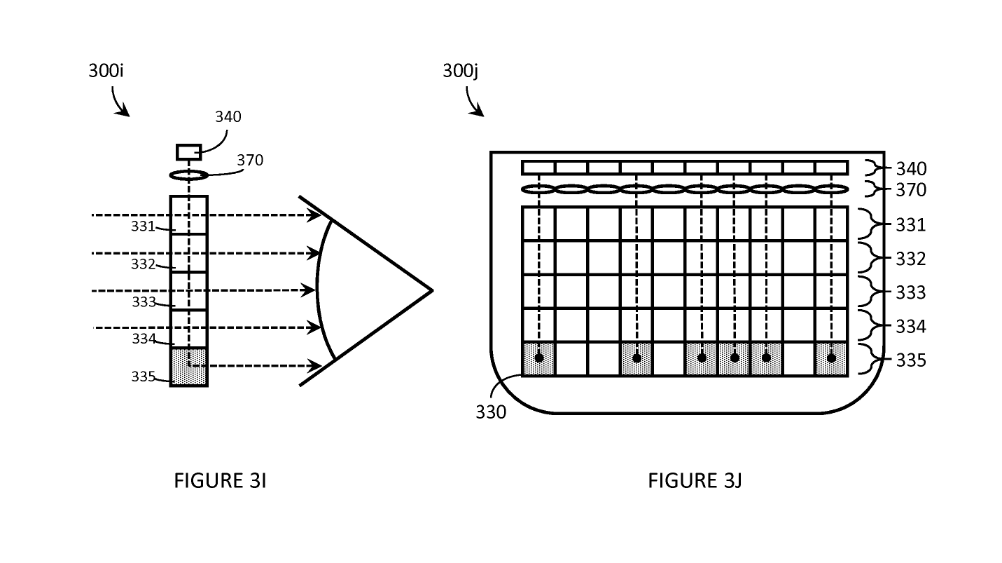

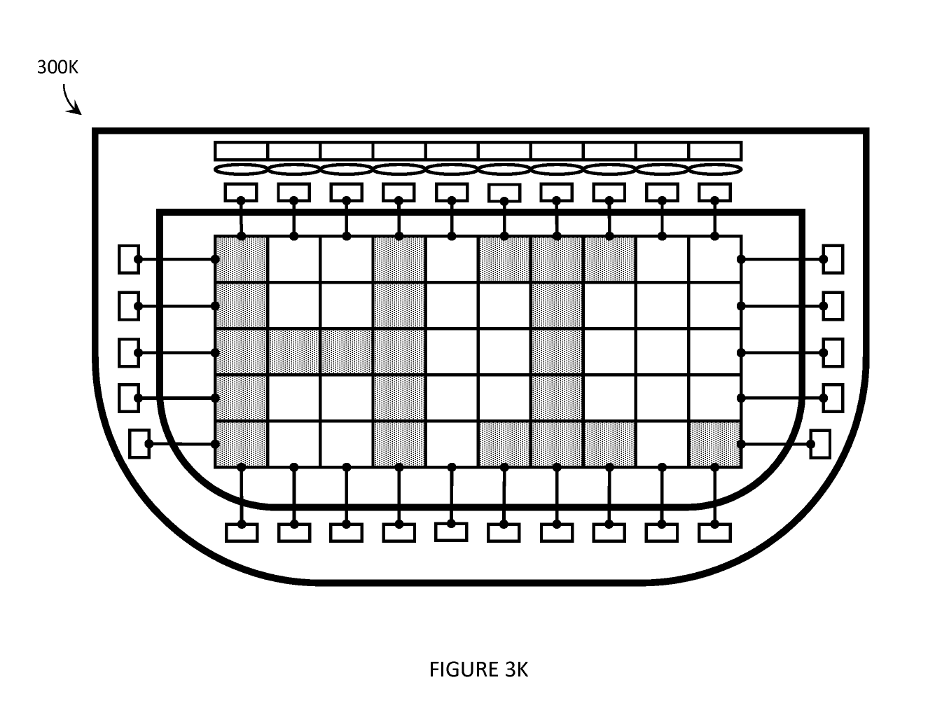

FIGS. 3A through 3K collectively provide an illustrative example of how the transparent displays described herein can be used to display an image in the same field of view as light from external sources. FIGS. 3A through 3K implement transparent displays that are substantially similar to transparent displays 100 and 200 from FIGS. 1 and 2, respectively.

FIGS. 3A and 3B are illustrative diagrams showing a side view and a front view, respectively, of a transparent display 300 in a first stage of an exemplary use in accordance with the present systems, articles, and methods. In the first stage of the exemplary use, a register of light sources 340 generates and emits a first set of light signals that together represent a first (i.e., topmost) row of pixels of an image. The first set of light signals are transmitted through collimators 370 and the resulting parallel beams are directed substantially in-plane with or co-planar to (e.g., through, over, or across) array of controllable reflectors 330. Since the first set of light signals correspond to the topmost row of pixels of the image, the controllable reflectors in the topmost row 331 of array of controllable reflectors 330 are each switched into their respective reflective configuration/state. Thus, light from external sources is transmitted through rows 332, 333, 334, and 335 of array of controllable reflectors 330 (because the corresponding individual controllable reflectors are each switched into their respective transparent configuration/state) to allow the user to see through display 300 while light signals from register 340 are reflected into the user's field of view from first row 331 of array of controllable reflectors 330.

FIGS. 3C and 3D are illustrative diagrams showing a side view and a front view, respectively, of transparent display 300 in a second stage of the exemplary use in accordance with the present systems, articles, and methods. In the second stage of the exemplary use, register of light sources 340 generates and emits a second set of light signals that together represent a second row of pixels of the image. The second set of light signals are transmitted through collimators 370 and the resulting parallel beams are directed substantially in-plane with or co-planar to (e.g., through, over, or across) array of controllable reflectors 330. Since the second set of light signals correspond to the second row of pixels of the image, the controllable reflectors in the second row 332 of array of controllable reflectors 330 are each switched into their respective reflective configuration/state. Thus, light from external sources is transmitted through rows 331, 333, 334, and 335 of array of controllable reflectors 330 (because the corresponding individual controllable reflectors are each switched into their respective transparent configuration/state) to allow the user to see through display 300 while light signals from register 340 are reflected into the user's field of view from second row 332 of array of controllable reflectors 330.

FIGS. 3E and 3F are illustrative diagrams showing a side view and a front view, respectively, of transparent display 300 in a third stage of the exemplary use in accordance with the present systems, articles, and methods. In the third stage of the exemplary use, register of light sources 340 generates and emits a third set of light signals that together represent a third row of pixels of the image. The third set of light signals are transmitted through collimators 370 and the resulting parallel beams are directed substantially in-plane with or co-planar to (e.g., through, over, or across) array of controllable reflectors 330. Since the third set of light signals correspond to the third row of pixels of the image, the controllable reflectors in the third row 333 of array of controllable reflectors 330 are each switched into their respective reflective configuration/state. Thus, light from external sources is transmitted through rows 331, 332, 334, and 335 of array of controllable reflectors 330 (because the corresponding individual controllable reflectors are each switched into their respective transparent configuration/state) to allow the user to see through display 300 while light signals from register 340 are reflected into the user's field of view from third row 333 of array of controllable reflectors 330.

FIGS. 3G and 3H are illustrative diagrams showing a side view and a front view, respectively, of transparent display 300 in a fourth stage of the exemplary use in accordance with the present systems, articles, and methods. In the fourth stage of the exemplary use, register of light sources 340 generates and emits a fourth set of light signals that together represent a fourth row of pixels of the image. The fourth set of light signals are transmitted through collimators 370 and the resulting parallel beams are directed substantially in-plane with or co-planar to (e.g., through, over, or across) array of controllable reflectors 330. Since the fourth set of light signals correspond to the fourth row of pixels of the image, the controllable reflectors in the fourth row 334 of array of controllable reflectors 330 are each switched into their respective reflective configuration/state. Thus, light from external sources is transmitted through rows 331, 332, 333, and 335 of array of controllable reflectors 330 (because the corresponding individual controllable reflectors are each switched into their respective transparent configuration/state) to allow the user to see through display 300 while light signals from register 340 are reflected into the user's field of view from fourth row 334 of array of controllable reflectors 330.

FIGS. 3I and 3J are illustrative diagrams showing a side view and a front view, respectively, of transparent display 300 in a fifth stage of the exemplary use in accordance with the present systems, articles, and methods. In the fifth stage of the exemplary use, register of light sources 340 generates and emits a fifth set of light signals that together represent a fifth (i.e., bottommost) row of pixels of the image. The fifth set of light signals are transmitted through collimators 370 and the resulting parallel beams are directed substantially in-plane with or co-planar to (e.g., through, over, or across) array of controllable reflectors 330. Since the fifth set of light signals correspond to the bottommost row of pixels of the image, the controllable reflectors in the bottommost row 335 of array of controllable reflectors 330 are each switched into their respective reflective configuration/state. Thus, light from external sources is transmitted through rows 331, 332, 333, and 334 of array of controllable reflectors 330 (because the corresponding individual controllable reflectors are each switched into their respective transparent configuration/state) to allow the user to see through display 300 while light signals from register 340 are reflected into the user's field of view from bottommost row 335 of array of controllable reflectors 330.

FIG. 3K is an illustrative diagram showing a front view of transparent display 300 and summarizing the cumulative effect of the exemplary use in accordance with the present systems, articles, and methods. In accordance with the present systems, articles, and apparatus, the light signals from register of light sources 340 and the configurations/states of the controllable reflectors in array of controllable reflectors 330 may be simultaneously (i.e., synchronously) switched, varied, cycled, or otherwise changed with sufficient rapidity (e.g., at a frequency on the order of tens or hundreds of Hz, kHz, or even MHz) such that the user's eye does not detect the latency between receiving the light signals corresponding to the first row of pixels (as per FIGS. 3A and 3B) and receiving the light signals corresponding to the last row of pixels (as per FIGS. 3I and 3J). The user sees a single cumulative image that projects upon, overlays, or otherwise shares the field of view with imagery from external sources and, in some implementations, may be tuned to exhibit varying degrees of transparency or opacity (e.g., by changing the frequency at which the light sources and controllable reflectors are switched). FIG. 3K demonstrates that the cumulative effect of the successive portions of an image displayed in the exemplary use depicted in FIGS. 3A through 3J is an image of the word “HI.” displayed on transparent display 300.

In accordance with the present systems, articles, and methods, at any given stage of a display cycle a majority of the controllable reflectors in the array of controllable reflectors are in a transparent configuration/state while a relatively small number of controllable reflectors are in a reflective configuration/state to achieve a high degree of optical transparency while the displays described herein are in use.

The transparent displays described herein may be used to display static or dynamic content (at virtually any resolution), including without limitation: text, images, maps, videos, menus, gauges, and/or dynamic user interfaces. As an example, 1080p video having a frame rate of 24 fps with a 16:9 aspect ratio may be displayed by a transparent display taught herein with an array of controllable reflectors having 1080 rows, a register of light sources having 1920 individual light sources, and with both the controllable reflectors and the light sources being capable of switching at a rate of about 26 kHz (i.e., 1080 rows multiplied by 24 frames). Such is entirely feasible using, for example OLED technology for light sources and either reflective microblinds, microelectromechanical (i.e., MEMS-based) mirrors, or tunable polarization for controllable reflectors.

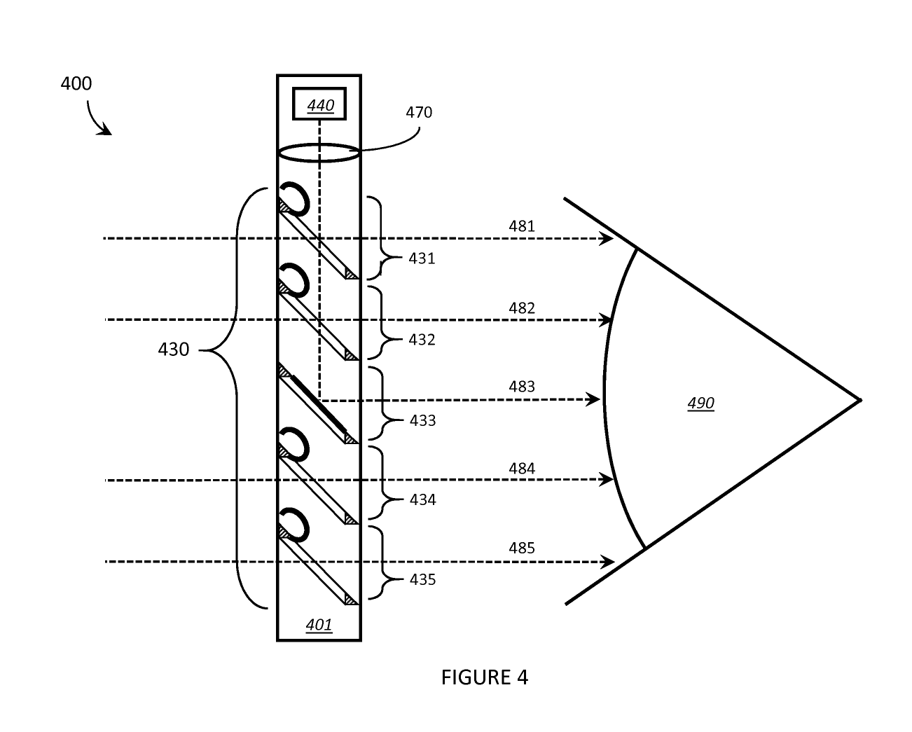

FIG. 4 is an illustrative diagram showing a side view of a transparent display 400 employing reflective microblinds 431, 432, 433, 434, and 435 in accordance with the present systems, articles, and methods. Transparent display 400 is substantially similar to transparent displays 100, 200, and 300 as previously described. Transparent display 400 includes a support structure 401, a register of light sources 440, a set of collimators 470, and an array of controllable reflectors 430. However, is the specific example of transparent display 400, each individual controllable reflector in array of controllable reflectors 430 is a respective reflective microblind 431, 432, 433, 434, and 435 that is oriented at an angle (e.g., approximately 45 degrees) to the path of a respective one of the light signals generated and emitted by register of light sources 440. Exemplary microblinds (and corresponding methods of manufacture) that may be used to implement microblinds 431, 432, 433, 434, and 435 are generally described in U.S. Pat. No. 7,684,105; however, the specific application in transparent displays described in the present systems, articles, and methods introduces two novel properties to the microblinds which are not taught in U.S. Pat. No. 7,684,105: i) the microblinds must be made of or coated with (on at least one surface) an optically reflective material, and ii) the microblinds must be oriented at an angle, such as approximately 45 degrees.

In accordance with the present systems, articles, and methods, each respective reflective microblind 431, 432, 433, 434, and 435, being adapted for use as a controllable reflector as described herein, includes: a substantially planar surface formed of a material that is substantially reflective, wherein the microblind is controllably switchable into and between at least two configurations, the at least two configurations including: i) a transparent (i.e., “open”) configuration in which the reflective microblind is open (e.g., microblinds 431, 432, 434, and 435 in FIG. 4) and light from external sources (481, 482, 484, and 485) within the field of view of at least one eye 490 of the user is transmitted through the reflective microblind; and ii) a reflective (i.e., “closed”) configuration in which the reflective microblind is closed (e.g., microblind 433 in FIG. 4), positioned within a path of the light signal (483) emitted by at least one light source in register of light sources 440, and oriented at an angle (e.g., 45 degrees) to the path of the light signal 483 emitted by the at least one light source in register of light sources 440. The light signal 483 emitted by the at least one light source in register of light sources 440 is reflected into the field of view of the at least one eye 490 of the user by microblind 433 while microblind 433 is in the reflective “closed” configuration. The precise angle at which microblinds 431, 432, 433, 434, and 435 are oriented depends on their relative positions and on the relative positions of the light sources, but in the exemplary illustration of FIG. 4 the angle at which microblinds 431, 432, 433, 434, and 435 are each oriented is approximately 45 degrees to reflect light signals (483) that are substantially in-plane with or co-planar to display 400 by about 90 degrees to cause such light signals (483) to be about normal to display 400 (and substantially parallel to the light from external sources 481, 482, 484, and 485) when they enter the eye 490 of the user.

A person of skill in the art will appreciate that reflective microblinds 431, 432, 433, 434, and 435 may be micro-scale elements having dimensions in the micrometer range. Such devices are typically fabricated by lithography processes by which it can be very difficult to produce uniform angles such as the about 45 degrees angles described herein. In accordance with the present systems, articles, and methods, the reflective microblinds described herein may be first fabricated as flat, planar devices on a flat, planar surface (e.g., having an angle of zero degrees), then diced (either individually or as complete rows), and then deposited on an angled surface of a transparent substrate, such as on an etched glass or a micro-molded plastic. That is, a transparent substrate may be etched, molded, or otherwise processed to form a sawtooth-like patterned surface and one or more respective segments, such as strips or rows, of reflective microblinds may be deposited on each angled portion of the sawtooth pattern.

As an alternative to the microblind configuration depicted in FIG. 4, devices based on tunable polarization may be used, in conjunction with reflective polarization filters, as the controllable reflectors described herein. For example, each respective controllable reflector in an array of controllable reflectors (e.g., 130, 230, 330) may include a respective tunable polarizer and a respective reflective polarization filter. Exemplary tunable polarizers include photoelastic modulators, Kerr cells, and Pockels cells, though a person of skill in the art will appreciate, in accordance with the present systems, articles, and methods, that virtually any mechanism of tuning polarization may be used.

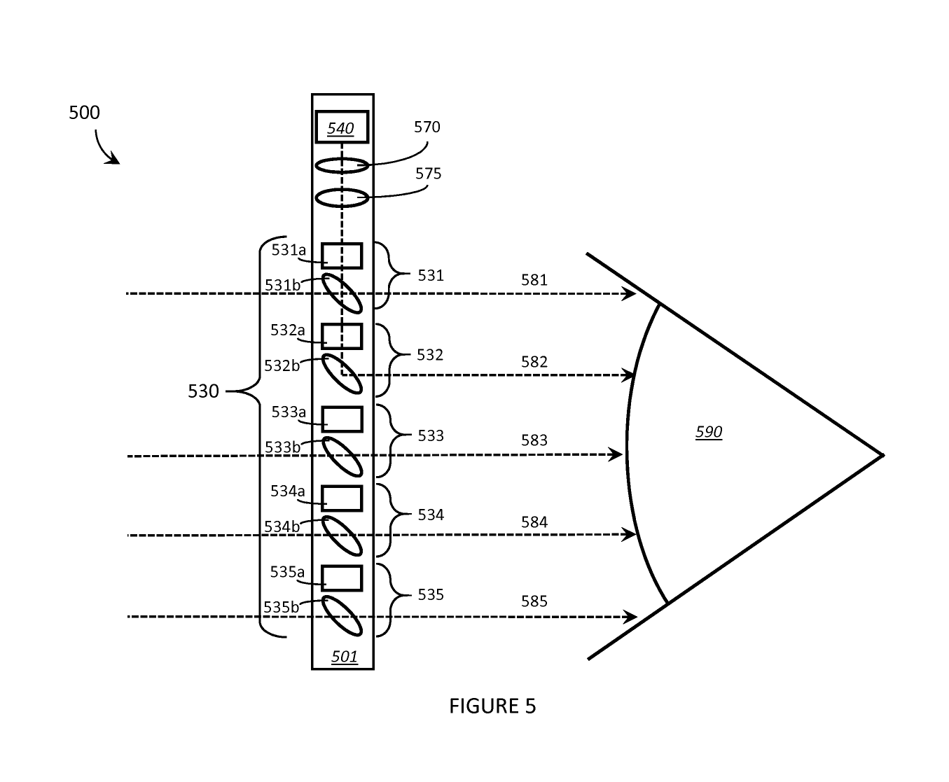

FIG. 5 is an illustrative diagram showing a side view of a transparent display 500 employing sequential Kerr cell shutters 531, 532, 533, 534, and 535 in accordance with the present systems, articles, and methods. A Kerr cell shutter is a high-speed device that uses a Kerr cell to tune the polarization of light passing therethrough between a first state in which the light will pass through a downstream polarization filter (i.e., because the polarization of the light matches that of the filter) and a second state in which the light will not pass through the downstream polarization filter (i.e., because the polarization of the light is substantially different from that of the filter). An example of a Kerr cell shutter is described in U.S. Pat. No. 3,408,133. In exemplary display 500 of FIG. 5, each controllable reflector is realized by a respective Kerr cell shutter 531, 532, 533, 534, 535, with each Kerr cell shutter 531, 532, 533, 534, 535 being serially coupled to at least one adjacent Kerr cell shutter 531, 532, 533, 534, 535 with respect to a path of the light signal 582 emitted by at least one light source in a register of light sources 540.

In detail, the controllable reflectors of transparent display 500 are realized by: a first set of polarizing elements 575 including at least one polarizing element having a first polarization, the first set of polarizing elements 575 positioned in between the register of light sources 540 and the array of controllable reflectors 530. In use, the first set of polarizing elements 575 apply the first polarization to the light signals 582 emitted by the light sources of the register of light sources 540; and a series of Kerr cell shutters 531, 532, 533, 534, 535, where each respective Kerr cell shutter includes: a Kerr cell 531a, 532a, 533a, 534a, 535a, respectively, that in use controllably alters the polarization of the light signal 582 emitted by at least one light source in register of light sources 540; and a reflective polarizing element 531b, 532b, 533b, 534b, 535b, respectively, having the first polarization, the reflective polarizing element 531b, 532b, 533b, 534b, 535b oriented at an angle (e.g., 45 degrees) to a path of the light signal 582 emitted by the at least one light source in register of light sources 540. In use each reflective polarizing element 531b, 532b, 533b, 534b, 535b: i) transmits the light signal 582 emitted by the at least one light source in register of light sources 540 when the corresponding Kerr cell 531a, 532a, 533a, 534a, 535a, respectively, is not operated to alter the polarization of the light signal 582; and ii) reflects the light signal 582 emitted by the at least one light source in register of light sources 540 when the corresponding Kerr cell 531a, 532a, 533a, 534a, 535a, respectively, is operated to alter the polarization of the light signal 582 and redirects, by said reflection, the light signal 582 into the field of view of at least one eye 590 of the user.

Similar to displays 100, 200, 300, and 400, display 500 also includes a set of at least one collimator 570 to collimate the light signals emitted by register of light sources 540.

In display 500, both the Kerr cells 531a, 532a, 533a, 534a, 535a and the reflective polarization filters 531b, 532b, 533b, 534b, 535b are at least partially transparent to light 581, 583, 584, 585 from external sources. Any activated Kerr cell 531a, 532a, 533a, 534a, 535a may alter the polarization of light 581, 583, 584, 585 from external sources, but such should not be appreciably detectable by the eye 590 of the user. Reflective polarization filters 531b, 532b, 533b, 534b, 535b may attenuate the light 581, 583, 584, 585 from external sources by transmitting only components of light 581, 583, 584, 585 that match the polarization thereof, but such should still provide an adequate level of optical transparency. If desired, display 500 may include one or more polarizing filter(s) in front of array of controllable reflectors 530 (with respect to the paths of light 581, 583, 584, 585 from external sources) in order to actively polarize light 581, 583, 584, 585 from external sources to increase transmission thereof through reflective polarization filters 531b, 532b, 533b, 534b, 535b.

The transparent displays described herein may be used in virtually any application requiring a display (e.g., as televisions, monitors, and the like) or in more specialized applications such as window display screens. In applications where a transparent display is typically viewed from a distance (i.e., on the order of meters) the collimators described may not be necessary. However, with the use of collimators, the transparent displays described herein are particularly well-suited for use in wearable heads-up display devices. In such devices, a single transparent display may be positioned in the field of view of one eye of the user while no transparent display is positioned in the field of view of the other eye of the user, or a single transparent display may be positioned in (and span) the fields of views of both eyes of the user, or a first transparent display (e.g., 100, 200, 300, 400, or 500) may be positioned in the field of view of a first eye of the user and a second transparent display (e.g., 100, 200, 300, 400, or 500) may be positioned in the field of view of a second eye of the user. In the latter case, the second transparent display may essentially duplicate the first transparent display.

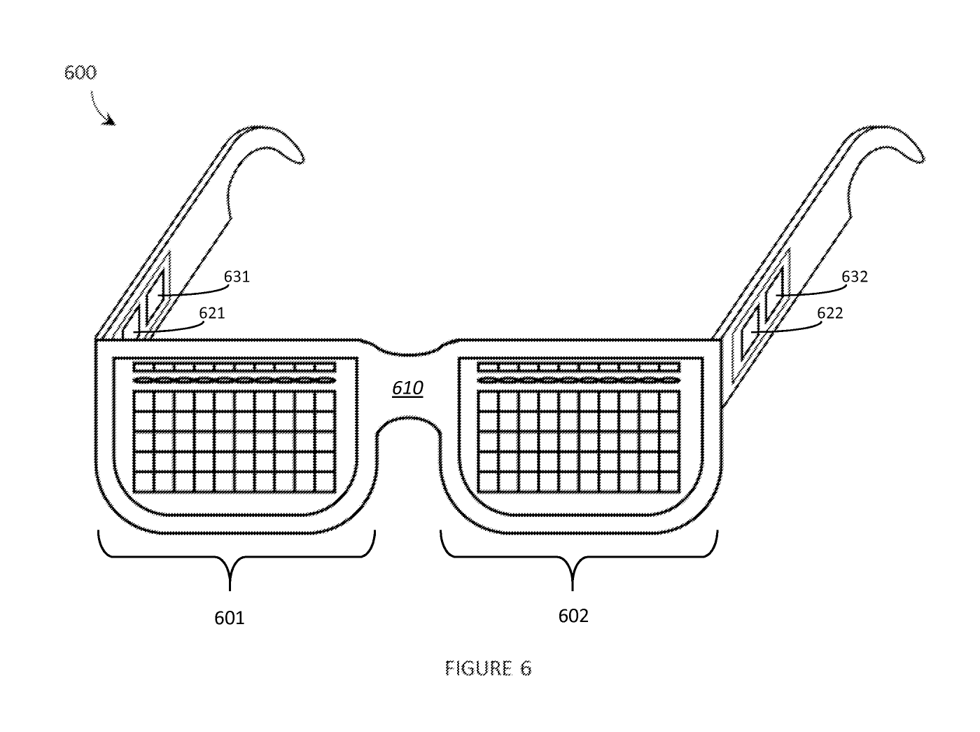

FIG. 6 is a perspective view of an exemplary wearable heads-up display 600 employing two transparent displays 601, 602 in accordance with the present systems, articles, and methods. Each of displays 601, 602 may be substantially similar to any of displays 100, 200, 300, 400, or 500 described previously. Wearable heads-up display 600 includes a support structure 610 having the general shape and appearance of an eyeglasses frame or a sunglasses frame and that, in use, is worn on a head of a user so that first display 601 is positioned within a field of view of a first eye of the user and second display 602 is positioned within a field of view of a second eye of the user. When worn on the head of the user, the first and second registers of light sources (not called out in FIG. 6 to reduce clutter) respectively corresponding to first and second displays 601 and 602 are preferably positioned near or beyond a periphery of the field of view of the corresponding eye of the user and first and second arrays of controllable reflectors (also not called out in FIG. 6 to reduce clutter) respectively corresponding to first and second displays 601 and 602 are preferably positioned within the field of view of the corresponding eye of the user. As shown in FIG. 6, the respective registers of light sources of each of displays 601 and 602 are positioned near the top of or above the fields of view of the corresponding eyes of the user; however, in alternative implementations one or more register(s) of light sources may be positioned near the bottom of or below the field of view of at least one eye of the user and/or near a side edge of or beside the field of view of at least one eye of the user.

In order to control the content displayed on first transparent display 601, wearable heads-up display 600 includes a first processor 621 physically coupled to support structure 610 and communicatively coupled to both the first register of light sources and the first array of controllable reflectors of first display 601; and a first non-transitory processor-readable storage medium 631 physically coupled to support structure 610 and communicatively coupled to first processor 621. First non-transitory processor-readable storage medium 631 stores processor-executable display control instructions that, when executed by first processor 621, cause first processor 621 to: control the respective light signal emitted by each light source in the first register of light sources of first display 601; and control the respective configuration of each controllable reflector in the first array of controllable reflectors of first display 601 (i.e., switch each controllable reflector in the first array of controllable reflectors into a respective one of the at least two configurations). In some implementations, a single processor and a single non-transitory processor-readable storage medium may control the operations of both first display 601 and second display 602; however, in the illustrated example of FIG. 6, wearable heads-up display 600 includes a second processor 622 and a second non-transitory processor-readable storage medium communicatively coupled thereto, and with a second set of processor-executable display control instructions stored therein, for controlling second display 602.

In some applications of wearable heads-up displays 600 that employ two transparent displays 601 and 602, both transparent displays 601 and 602 may simultaneously (e.g., synchronously) display visual content to the user. However, in other applications, it may be advantageous to rapidly alternate which of the two displays 601 and 602 is displaying content to the user while the other of displays 602 and 601 is in a state of maximal transparency. For example, in an application in which video is displayed to a user, all odd frames may be displayed on first display 601 while second display 602 is in a state of maximal transparency (i.e., with all controllable reflectors in their respective transparent configuration) and all even frames may be displayed on second display 602 while first display 601 is in a state of maximal transparency. This approach can maximize the user's perception of light from external sources without noticeably detracting from the quality of the content displayed on or by displays 601 and 602. Similar techniques are employed in, for example, shutter-based 3D glasses.

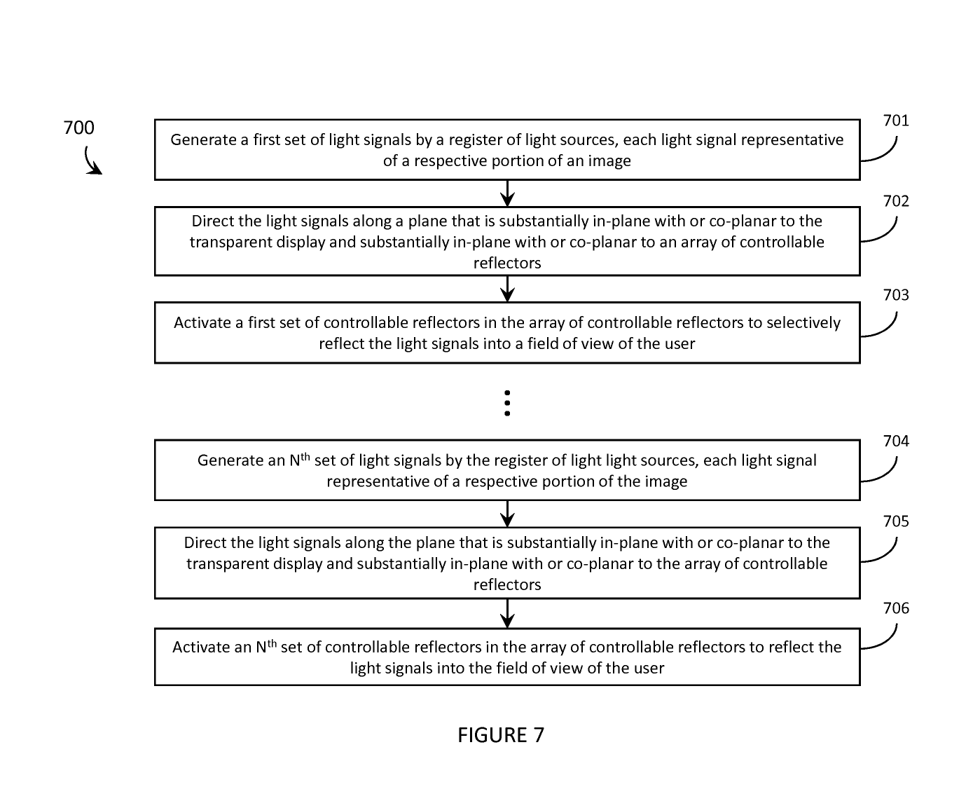

FIG. 7 is a flow-diagram showing a method 700 of operating at least one transparent display of a wearable heads-up display when the wearable heads-up display is worn on a head of a user in accordance with the present systems, articles, and methods. Method 700 includes six acts 701, 702, 703, 704, 705, and 706, though those of skill in the art will appreciate that in alternative embodiments certain acts may be omitted and/or additional acts may be added. In particular, as described in more details below, one or more repetitions of acts 701, 702, and 703 may be included in between act 703 and 704 for one or more additional set(s) of light signals representative of one or more additional portion(s) of an image. Those of skill in the art will also appreciate that the illustrated order of the acts is shown for exemplary purposes only and may change in alternative embodiments. For the purpose of method 700, the term “user” refers to a person that is wearing the wearable heads-up display (e.g., 600).

At 701, a register of light sources (being a component of the transparent display; e.g., 140) generates a first set of light signals, each light signal representative of a respective portion of an image. The register of light sources may include LEDs and/or OLEDs of any number of colors. If the register of light sources (140) is arranged in a row and positioned above or below the field of view of the user, then the portions of the image represented by the first set of light signals may, collectively, correspond to a first row of the image. Alternatively, if the register of light sources (140) is arranged in a column and positioned beside the field of view of the user, then the portions of the image represented by the first set of light signals may, collectively, correspond to a first column of the image.

At 702, the light signals are directed along a plane that is substantially in-plane with or co-planar to the transparent display and substantially in-plane with or co-planar to an array of controllable reflectors (also being a component of the transparent display; e.g., 130). In this way, the light signals are initially directed along a plane that is outside of (e.g., perpendicular to) the field of view of the user.

At 703, a first set of controllable reflectors in the array of controllable reflectors (e.g., 130) is activated (e.g., by an on-board processor, such as processor 621) to selectively reflect the light signals into a field of view of at least one eye of the user. For example, the first set of controllable reflectors in the array of controllable reflectors may be oriented at an angle (e.g., at a 45 degree angle) with respect to the plane of the light signals so that when the first set of controllable reflectors in the array of controllable reflectors is activated to reflect the light signals, the light signals are redirected (by, e.g., about 90 degrees) into the field of view of the user. If the light signals in the first set of light signals are, collectively, representative of a first row of the image, then a first row of controllable reflectors in the array of controllable reflectors may be activated at 703. Similarly, if the light signals corresponding to the first set of light signals are, collectively, representative of a first column of the image, then a first column of controllable reflectors in the array of controllable reflectors may be activated at 703. In general, each controllable reflector activated at 703 substantially corresponds to the position of the portion of the image represented by the light signal impinging thereon from a corresponding light source in the register of light sources and reflecting therefrom into the field of view of the user. While “rows” and “columns” of the image are used as exemplary implementations in this description, the light signals corresponding to the first set of light signals are not required to collectively represent a line or linear portion of the image.

Acts 701, 702, and 703 may be repeated sequentially for multiple sets of light signals respectively corresponding to (i.e., representative of) multiple portions of the image. For example, acts 701, 702, and 703 may be repeated for a second and/or at least one additional set of light signals corresponding to (i.e., representative of) a second and/or at least one additional portion (e.g., a second and/or at least one additional row or column) of the image using a second and/or at least one additional set of controllable reflectors of the array of controllable reflectors. When the image includes N rows, where N is an integer greater than 1, and the first set of light signals generated at 701 collectively represent a first row of the image, then method 700 may include, until i=(N+1), where i is an integer with an initial value of 2, sequentially: generating an i^{th} set of light signals by the register of light sources similar to act 701, the i^{th} set of light signals representative of an i^{th} row of the image; directing light signals in the i^{th} set of light signals along the plane that is substantially in-plane with or co-planar to the at least one transparent display and substantially in-plane with or co-planar to the array of controllable reflectors, similar to act 702; activating an i^{th} row of controllable reflectors in the array of controllable reflectors to reflect the light signals into the field of view of at least one eye of the user similar to act 703; and incrementing i by 1.

In general, method 700 may include sequentially repeating acts 701, 702, and 703 for successive portions (e.g., rows or columns) of the image until the N^{th} or final portion of the image is reached. Once the N^{th} or final portion of the image is reached, method 700 may proceed to act 704.

At 704, an N^{th} set of light signals is generated by the register of light sources similar to act 701, each light signal representative a respective portion of the image.

At 705, the light signals are directed along the plane that is substantially in-plane with or co-planar to the transparent display and substantially in-plane with or co-planar to the array of controllable reflectors, similar to act 702.

At 706, an N^{th} set of controllable reflectors in the array of controllable reflectors is activated to reflect the light signals into the field of view of at least one eye of the user similar to act 703.

As previously described, the array of controllable reflectors may include an array of reflective microblinds. In this case, activating the first set of controllable reflectors per act 703 may include closing a first set of reflective microblinds to selectively reflect the light signals into the field of view of at least one eye of the user. Alternatively, the array of controllable reflectors may employ MEMS-based mirrors that, upon actuation, selectively move in and out of the plane in which the light signals travel from the registers of light sources in order to reflect such light signals into the field of view of the user. As another alternative, the array of controllable reflectors may employ tunable polarization elements, such as photoelastic modulators, Kerr cells, and/or Pockels cells. In this case, method 700 may include polarizing the light signals to a first polarization by at least one polarizer somewhere in between acts 701 and 703. When the array of controllable reflectors includes an array of Kerr cell shutters, each Kerr cell shutter including a respective Kerr cell and a respective reflective polarizing element, activating a first set of controllable reflectors per act 703 may include: altering the first polarization of the light signals to a second polarization by a first set of Kerr cells; and reflecting the light signals into the field of view of at least one eye of the user by a first set of reflective polarizers.

As previously described, a user may be better able to focus on images displayed on the transparent displays described herein when employed in wearable heads-up displays if the light signals are directed in substantially parallel beams. To this end, method 700 may include collimating the light signals by at least one collimator.

Furthermore, the wearable heads-up display may include a processor and a non-transitory processor-readable storage medium communicatively coupled to the processor that together control at least some of the acts of method 700. For example, generating a first set of light signals by a register of light sources per act 701 may include generating the first set of light signals by the register of light sources in response to at least a first control signal provided by the processor based on executing, by the processor, processor-executable display control instructions stored in the non-transitory processor-readable storage medium; and activating a first set of controllable reflectors in the array of controllable reflectors to selectively reflect the light signals into a field of view of at least one eye of the user per act 703 may include activating the first set of controllable reflectors in the array of controllable reflectors to selectively reflect the light signals into the field of view of at least one eye of the user in response to at least a second control signal provided by the processor based on executing, by the processor, processor-executable display control instructions stored in the non-transitory processor-readable storage medium.

The wearable heads-up displays described herein may include one or more sensor(s) (e.g., microphone, camera, thermometer, compass, eye-tracker, and/or others) for collecting data from the user and/or from the user's environment. For example, one or more camera(s) may be used to provide feedback to the processor of the wearable heads-up display and influence where on the transparent display(s) any given image should be displayed.

The wearable heads-up displays described herein may receive and respond to commands from the user in one or more of a variety of ways, including without limitation: voice commands through a microphone; touch commands through buttons, switches, or a touch sensitive surface; and/or gesture-based commands through gesture detection systems as described in, for example, U.S. Non-Provisional patent application Ser. No. 14/155,087 and U.S. Non-Provisional patent application Ser. No. 14/155,107, both of which are incorporated by reference herein in their entirety.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), and/or optical pathways (e.g., optical fiber), and exemplary communicative couplings include, but are not limited to, electrical couplings, magnetic couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a processor-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the processor-readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, U.S. Provisional Patent Application Ser. No. 61/928,568; U.S. Pat. No. 7,684,105, U.S. Non-Provisional patent application Ser. No. 14/155,087, and U.S. Non-Provisional patent application Ser. No. 14/155,107, are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A wearable heads-up display comprising:
a support structure that in use is worn on a head of a user; and
a first transparent display that is physically coupled to the support structure, wherein the first transparent display is substantially planar and positioned within a field of view of the user when the support structure is worn on the head of the user, and wherein the first transparent display comprises:
a first register of light sources positioned near or beyond a periphery of the field of view of the user when the support structure is worn on the head of the user, wherein each light source in the first register of light sources controllably emits a respective light signal substantially in-plane with or co-planar to the first transparent display; and
a first array of controllable reflectors arranged substantially in-plane with or co-planar to the first transparent display and positioned within the field of view of the user when the support structure is worn on the head of the user, wherein each controllable reflector in the first array of controllable reflectors is controllably switchable into and between at least two configurations, the at least two configurations including:
i) a transparent configuration in which light from external sources within the field of view of the user is transmitted through the controllable reflector and a light signal emitted by a light source in the first register of light sources, if impingent on the controllable reflector, is also transmitted through the controllable reflector; and
ii) a reflective configuration in which a light signal emitted by at least one light source in the first register of light sources is reflected by the controllable reflector into the field of view of the user.

2. The wearable heads-up display of claim 1 wherein the first transparent display is positioned within a field of view of a first eye of the user when the support structure is worn on the head of the user, and further comprising:
a second transparent display physically coupled to the support structure, wherein the second transparent display is substantially planar and positioned within a field of view of a second eye of the user when the support structure is worn on the head of the user, and wherein the second transparent display comprises:
a second register of light sources positioned near or beyond a periphery of the field of view of the second eye of the user when the support structure is worn on the head of the user, wherein each light source in the second register of light sources controllably emits a respective light signal substantially in-plane with or co-planar to the second transparent display; and
a second array of controllable reflectors arranged substantially in-plane with or co-planar to the second transparent display and positioned within the field of view of the second eye of the user when the support structure is worn on the head of the user, wherein each controllable reflector in the second array of controllable reflectors is controllably switchable into and between at least two configurations, the at least two configurations including:
i) a transparent configuration in which light from external sources within the field of view of the second eye of the user is transmitted through the controllable reflector and a light signal emitted by a light source in the second register of light sources, if impingent on the controllable reflector, is also transmitted through the controllable reflector; and
ii) a reflective configuration in which a light signal emitted by at least one light source in the second register of light sources is reflected by the controllable reflector into the field of view of the second eye of the user.

3. The wearable heads-up display of claim 2 wherein the support structure has a general shape and appearance of an eyeglasses frame.

4. The wearable heads-up display of claim 1, further comprising:
a processor physically coupled to the support structure and communicatively coupled to both the first register of light sources and the first array of controllable reflectors; and
a non-transitory processor-readable storage medium physically coupled to the support structure and communicatively coupled to the processor, wherein the non-transitory processor-readable storage medium stores processor-executable display control instructions that, when executed by the processor, cause the processor to:
control the respective light signal emitted by each light source in the first register of light sources; and
control the respective configuration of each controllable reflector in the first array of controllable reflectors.

5. The wearable heads-up display of claim 1 wherein each respective light source in the first register of light sources includes at least one light source selected from the group consisting of: a respective light-emitting diode and a respective organic light-emitting diode.

6. The wearable heads-up display of claim 1 wherein the first array of controllable reflectors includes X rows and Y columns, wherein X and Y are both integers greater than zero, and wherein the first array of controllable reflectors further comprises:
a first set of X control signal lines, each control signal line in the first set of X control signal lines communicatively coupled to all of the controllable reflectors in a respective row of the first array of controllable reflectors.

7. The wearable heads-up display of claim 6 wherein the first array of controllable reflectors further comprises:
a second set of Y control signal lines, each control signal line in the second set of Y control signal lines communicatively coupled to all of the controllable reflectors in a respective column of the first array of controllable reflectors.

8. The wearable heads-up display of claim 1 wherein each controllable reflector in the first array of controllable reflectors includes a respective reflective microblind comprising:
a surface formed of a material that is substantially reflective, wherein the reflective microblind is controllably switchable into and between at least two configurations, the at least two configurations including:
i) an open configuration in which the reflective microblind is open and light from external sources within the field of view of the user is transmitted through the reflective microblind and a light signal emitted by a light source in the first register of light sources, if impingent on the reflective microblind, is also transmitted through the reflective microblind; and
ii) a closed configuration in which the reflective microblind is closed and positioned within a path of a light signal emitted by at least one light source in the first register of sources, wherein the light signal emitted by the at least one light source in the first register of light sources is reflected into the field of view of the user by the reflective microblind when the reflective microblind is in the closed configuration.

9. The wearable heads-up display of claim 8 wherein, for the closed configuration of each respective reflective microblind, the reflective microblind is oriented at an approximately 45 degree angle relative to the path of the light signal emitted by the at least one light source in the first register of light sources.

10. The wearable heads-up display of claim 1 wherein each respective controllable reflector in the first array of controllable reflectors comprises a respective photoelastic modulator.

11. The wearable heads-up display of claim 1 wherein each respective controllable reflector in the first array of controllable reflectors comprises a respective Kerr cell.

12. The wearable heads-up display of claim 1, further comprising:
a first set of collimators, each collimator in the first set of collimators positioned adjacent a respective one of the light sources in the first register of light sources, wherein each collimator in the first set of collimators directs the light signal emitted by a respective light source in the first register of light sources along a direction that is both:
i) substantially in-plane with or co-planar to the first transparent display; and
ii) substantially parallel to the respective light signals emitted by the other light sources in the first register of light sources.

13. A method of operating a transparent display of a wearable heads-up display when the wearable heads-up display is worn on a head of a user, the method comprising:
generating a first set of light signals by a register of light sources, each light signal representative of a respective portion of an image;
directing the light signals along a plane that is substantially in-plane with or co-planar to the transparent display and substantially in-plane with or co-planar to an array of controllable reflectors; and
activating a first set of controllable reflectors in the array of controllable reflectors to selectively reflect the light signals into a field of view of the user.

14. The method of claim 13, further comprising:
generating a second set of light signals by the register of light sources, each light signal in the second set of light signals representative of a respective portion of the image;
directing the light signals in the second set of light signals along the plane that is substantially in-plane with or co-planar to the transparent display and substantially in-plane with or co-planar to the array of controllable reflectors; and
activating a second set of controllable reflectors in the array of controllable reflectors to selectively reflect the light signals in the second set of light signals into the field of view of the user.

15. The method of claim 13 wherein the first set of light signals collectively represent a first row portion of the image, and wherein activating a first set of controllable reflectors in the array of controllable reflectors to selectively reflect the light signals into a field of view of the user includes activating a first row of controllable reflectors in the array of controllable reflectors to selectively reflect the light signals into a field of view of the user.

16. The method of claim 13 wherein the image includes N rows, where N is an integer greater than 1, and the first set of light signals collectively represent a first row of the image, the method further comprising:
until i=(N+1), where i is an integer with an initial value of 2, sequentially:
generating an i^{th} set of light signals by the register of light sources, the i^{th} set of light signals representative of an i^{th} row of the image;
directing light signals in the i^{th} set of light signals along the plane that is substantially in-plane with or co-planar to the at least one transparent display and substantially in-plane with or co-planar to the array of controllable reflectors;
activating an i^{th} row of controllable reflectors in the array of controllable reflectors to reflect the light signals in the i^{th} set of light signals into the field of view of the user; and
incrementing i by 1.

17. The method of claim 13 wherein the array of controllable reflectors includes an array of reflective microblinds, and wherein activating a first set of controllable reflectors in the array of controllable reflectors to selectively reflect the light signals into a field of view of the user includes closing a first set of reflective microblinds in the array of reflective microblinds to selectively reflect the light signals into the field of view of the user from the closed first set of reflective microblinds.

18. The method of claim 13, further comprising:
collimating the light signals by at least one collimator.

19. The method of claim 13 wherein the wearable heads-up display includes a processor and a non-transitory processor-readable storage medium communicatively coupled to the processor, wherein the non-transitory processor-readable storage medium stores processor executable display control instructions, and wherein:
generating a first set of light signals by the register of light sources includes executing the processor-executable display control instructions by the processor to cause the register of light sources to generate the first set of light signals; and
activating a first set of controllable reflectors in the array of controllable reflectors to reflect the light signals into a field of view of the user includes executing the processor-executable display control instructions by the processor to cause the first set of controllable reflectors in the array of controllable reflectors to reflect the light signals into the field of view of the user.

20. The method of claim 13 wherein activating a first set of controllable reflectors in the array of controllable reflectors to selectively reflect the light signals into a field of view of the user includes, for each light signal in the first set of light signals, activating the controllable reflector in the array of controllable reflectors that corresponds to the position of the portion of the image represented by that light signal.
